(19) United States
(12) Patent Application Publication
(10) Pub. No.: US 2013/0319547 A1
(43) Pub. Date: Dec. 5, 2013

(54) CIRCUIT BOARD HAVING A PRESSURE-RELIEF VALVE, INSUFFLATOR

(71) Applicants: Lienhard Pagel, Klockenhagen (DE); Stefan Gassmann, Rostock (DE)

(72) Inventors: Lienhard Pagel, Klockenhagen (DE); Stefan Gassmann, Rostock (DE)

(73) Assignee: MGB ENDOSKOPISCHE GERATE GMBH, Berlin (DE)

(21) Appl. No.: 13/980,677

(22) PCT Filed: Jan. 23, 2012
(86) PCT No.: PCT/EP12/50973

§ 371 Date: Aug. 26, 2013

(30) Foreign Application Priority Data
Jan. 21, 2011 (DE) 10 2011 003 007.7

(51) Int. Cl. F16K 17/00

(52) U.S. Cl. CPC F16K 17/00
USPC 137/505

(57) ABSTRACT

The present invention concerns a circuit board (100) having at least one fluid passage (110) arranged in the interior of a circuit board (100), having a fluid passage opening (120) which is arranged on a surface of the circuit board (100) and which leads to the fluid passage (110, and a multi-part pressure-relief valve arrangement (200) for reducing an excess pressure in the fluid passage (110), which includes a first magnet (210), a second magnet (220) and a sealing closure (230), wherein the first magnet (210) and the second magnet (220) are so arranged that they press the sealing closure (230) on to the fluid passage opening (2120) by a magnetic force (250) afforded by the first magnet (210) and by the second magnet (220).

The present invention concerns a circuit board having at least one fluid passage arranged in the interior of the circuit board and a multi-part pressure-relief valve arrangement for reducing an excess pressure in the fluid passage. The invention further concerns an insufflator having such a circuit board.

A circuit board as a support for electronic components, which includes one or more fluid passages in the interior of the circuit board, is known. The fluid passages in the interior of the circuit board carry for example a fluid like a liquid which serves during operation to cool electronic components arranged on the circuit board. The use of such a circuit board is also known in a fluidic microsystem in which the fluid passages in the interior of the circuit board carry a fluid which is used for other primary purposes than for cooling components. Such a microfluidic system is used for example in fields such as biotechnology, medical engineering, process technology, sensor engineering but also in relation to consumer goods.

A circuit board with fluid passages arranged in the interior thereof is known for example from published specification DE 197 39 722 A1. That previously known circuit board has a plurality of layers on which conductor tracks are so arranged that there are intermediate spaces which can be used as passages for fluids. Provided in selected layers are openings into which sensors can be fitted so that the sensors have direct contact with a fluid flowing in the fluid passages.

Pressure-relief valves are used for reducing an excess pressure in a fluid passage. Such a pressure-relief valve is known for example from the publication: F Peridigones et al: “Safety valve in PCB-MEMS technology for limiting pressure in microfluidic applications”, 2010 IEEE, international Conference on Industrial Technology, Mar. 14 through 17, 2010, pages 1558-1561, The pressure-relief valve previously known from that publication is of a bridge-like structure in which a flexible suspended beam is extended as an intermittent closure portion over an opening in the circuit board which leads to the fluid passage. When the pressure in the fluid passage and thus on the closure portion rises the part of the valve extending over the opening is bent in the direction of the circuit board in such a way that the opening is blocked and thus the fluid in the fluid passage in question is interrupted. That prevents a further increase in pressure. In that respect the previously known pressure valve would rather be referred to as a pressure regulator as a fluid supply by way of an inlet is interrupted by closure of the inlet and it is not the case that a fluid system is opened for pressure reduction, as is otherwise usual with a valve. A disadvantage with the previously known pressure-relief valve is the complicated and expensive structure as well as the complicated dimensioning of the components involved for attaining the desired operative principle in the case of an actual circuit board.

A technical object of the present invention is to propose a circuit board having at least one fluid passage arranged in the interior of the circuit board, which is both inexpensive to produce and which also offers a high level of operational reliability and safety.

In a first aspect that object is attained for a circuit board having at least one fluid passage in the interior of the circuit board, which has the following components:
a fluid passage opening which is arranged on a surface of the circuit board and which leads to the fluid passage, and
a multi-part pressure-relief valve arrangement for reducing an excess pressure in the fluid passage, which includes a first magnet, a second magnet and a sealing closure, wherein
the first magnet and the second magnet are so arranged that they press the sealing closure on to the fluid passage opening by a magnetic force afforded by the first magnet and by the second magnet.

The invention involves the realization that a pressure-relief valve of a circuit board is an element which is important and sometimes necessary for operational reliability and safety, but that previously known solutions are of a complex structure, they are complicated in terms of dimensioning and they are accordingly costly. A previously known pressure-relief valve on a circuit board therefore diminishes advantages in principle of a circuit board with fluid passages, namely the inexpensive and compact union of fluidics and electronics.

Unlike the previously known pressure-relief valve the pressure-relief valve arrangement according to the invention is operative not at the inlet of the fluid passage but at an outlet and more specifically in such a way that the pressure-relief valve arrangement opens at a currently prevailing excess pressure and thus prevents a higher pressure obtaining in the fluid passage, than is required for opening the excess pressure-relief valve arrangement.

The present excess pressure-relief valve arrangement with the first and second magnets and with the sealing closure represents a particularly inexpensive and compact alternative. The two magnets and the sealing closure can be very easily installed and perform their technical function, namely reducing an excess pressure obtaining in the fluid passage, in a fashion which is improved over previously known solutions, In particular the pressure-relief valve arrangement does not require any additional housing or the like. The pressure-relief valve arrangement also does not require any particular valve holders, valve mounting means or valve centering devices. The costs of the pressure-relief valve arrangement are a multiple less than the costs which would be involved for a comparable spring-operated pressure-relief valve.

Unlike for example the case with a spring-operated valve the magnetic force between the first and the second magnets, that is to say the force with which the sealing closure is pressed on to the fluid passage opening (hereinafter also referred to as the closing force) is mostly approximately proportional to the inverse of the square of the spacing between the first and second magnets, If the pressure in the fluid passage rises above a predetermined maximum pressure then the pressure-relief valve arrangement opens, in which case the spacing between the first and second magnets is increased for that purpose and thus the closing force decreases. That promotes further opening when the pressure in the fluid passage is possibly still rising, and this therefore guarantees a rapid reduction in pressure. The pressure-relief valve arrangement thus presents a hysteresis characteristic as it closes at a pressure which is below the predetermined maximum pressure at which it opens. Therefore the present pressure-relief valve arrangement of the circuit board is more reliable in terms of closure than previously known valves as the closing force increases with decreasing spacing. In contrast thereto, for example in the case of a valve operating with a spring, the closing force in the case of valve opening caused by an excess pressure, does not fall but increases.

The simple structure of the pressure-relief valve arrangement which substantially comprises only three components, namely the first magnet and the second magnet as well as the sealing closure, provides that the pressure-relief valve arrangement is easy to integrate in the circuit board. It is also possible for the above-mentioned components of the pressure-relief valve arrangement to be installed with an automatic fitment apparatus when implementing the circuit board so that no particular complication or expenditure is also involved in terms of installation of the pressure-relief valve arrangement. The advantages of the circuit board with an integrated fluid passage, namely the inexpensive and compact conjunction of fluidics and electronics, is not for example diminished by the additional provision of the pressure-relief valve arrangement, but confirmed.

A further advantage of the circuit board according to the invention lies in a broad range of values in which the magnetic force between the first and second magnets can be adjusted. For example the magnetic force which in the context of the description of this invention is also referred to as the closing force can be adjusted by the selection of a given magnet material or by the shape and dimensioning of the first and/or second magnet.

The first magnet can be for example a permanent magnet. The second magnet can for example also be a permanent magnet or can comprise ferromagnetic material and/or can be a soft iron. The terms “first magnet” and “second magnet” are to be interpreted technically functionally in the context of the description of the present invention in such a way that a magnetic force acts between them. That means for example that it is sufficient that only the first or the second magnet actually comprises magnetic material, but the other magnet for example can be metallic, that is to say of ferromagnetic material like a soft iron.

A further advantage of the circuit board is that the pressure-relief valve arrangement after opening because of an excess pressure in the fluid passage can be quickly closed again. A complicated and expensive operation of re-fitting in valve holders or screwing the valve in place or similar re-installation operations are not required. Added to that is the fact that the first and second magnets are preferably so arranged that the magnetic force presses the sealing closure against the fluid passage opening in centering relationship and in that respect complicated positioning is also redundant.

Some embodiments of the circuit board according to the invention in the first aspect of the invention are described hereinafter. Additional features of these embodiments can be combined together to form further variants, insofar as they are not expressly identified as alternative to each other.

Basically the pressure-relief valve arrangement can be so designed that it remains in the opened condition after an excess pressure in the fluid passage or however it can be so designed that, after an excess pressure in the fluid passage, it automatically goes back into the closed condition again.

In a preferred embodiment the first magnet is fixed on the moveable sealing closure and the second magnet is fixed on a side of the circuit board, that is remote from the fluid passage opening. For example the first magnet arranged on the sealing closure can be a permanent magnet while the second magnet can be a metallic plate arranged on the side of the circuit board, that is remote from the fluid passage opening. That embodiment has the advantage of a simple structure which can preferably also be produced by an automatic fitment apparatus in the context of equipping the circuit board.

Particularly preferably the first and second magnets of the pressure-relief valve arrangement of the circuit board are so arranged that the magnetic force acting between them acts in opposition to a displacement of the first magnet out of a central position. Accordingly the two magnets have a self-centering and self-guiding action, which is to the benefit of an advantageous opening and closing characteristic of the pressure-relief valve arrangement. In particular the pressure-relief valve arrangement thus automatically avoids the sealing closure bearing against the fluid passage opening in tilted relationship. For example therefore the second magnet is arranged integrated in the circuit board on the side thereof, that is remote from the fluid passage, and is disposed above the second magnet of the sealing closure together with the first magnet on the fluid passage opening.

To achieve the above-mentioned advantageous effect it is desirable if the first magnet and the second magnet have mutually facing surfaces which are respectively arranged as mutually centered as possible and substantially perpendicular to a notional vertical axis and are of substantially the same shape and size. By virtue of the magnetic force between the first and second magnets this pressure-relief valve arrangement has a self-centering action as the magnetic force counteracts displacement of the first magnet out of a notional projected surface parallel to the surface of the second magnet, more specifically both tilting of the first magnet and also horizontal displacement.

To achieve a compact structure for the circuit board according to the invention it is further desirable if the second magnet is embedded in an opening in the circuit board. For example the second magnet can be fixed in that opening in the manner of an inlay, in particular it can be glued therein.

The first magnet is preferably glued on the sealing closure. The second magnet is preferably glued on the side of the circuit board, that is remote from the fluid passage opening.

It is also desirable for a compact circuit board structure if the first magnet and the second magnet respectively have a planar body in which the width is substantially greater than the height. In that way it is possible to provide that the pressure-relief valve arrangement has a flat structure which, if at all, scarcely stands up from other components on the circuit board, For example the planar body is of a width which is at least twice as great and preferably at least three times as great as the height. It is also possible to conceive of a disc-shaped body, that is to say a cylinder of a height of 2.5 mm and a diameter of 12 mm.

Preferably the overall height of the pressure-relief valve arrangement is below 1 cm.

To minimize the overall height of the pressure-relief valve arrangement it is preferable if the sealing closure has a sealing element like an O-ring which in the closed condition of the pressure-relief valve arrangement is embedded in openings in the circuit board. Such openings can be for example those which are normally provided for electric conductor tracks on the surface of the circuit board. It will also be clear therefrom that the overall pressure-relief valve arrangement does not require any particular complication or expenditure which goes far beyond the usual level involved in equipping a circuit board; openings which are possibly provided on the surface of the circuit board can be produced with means which are in any case already involved for producing the openings for conductor tracks. The first magnet can for example already be glued on the sealing closure. The first magnet with the sealing closure and the second magnet can then be positioned on the circuit board with an automatic fitting apparatus so that a circuit board in the fully equipped and finished condition is already provided with the pressure-relief valve arrangement in the closed condition.

The sealing element of the sealing closure can be for example an O-ring or a stamped flat seal, but basically can be of any design configuration, and accordingly can also differ from the form of the 0-ring or the stamped flat seal.

The second magnet can be for example an inlay, for example of iron or ferrite. A circuit board manufacturer can equally laminate such an inlay into the circuit board.

So that the first magnet and the sealing closure are not simply detached from the circuit board in the event of a great excess pressure in the fluid passage and the magnetic force is no longer sufficient to re-position the first magnet with the sealing closure after the reduction in the excess pressure, it is desirable if the circuit board includes an additional electronic component like a passive electronic component like a resistor, a capacitor or a wiring bridge or like an active electronic component like a transistor or an integrated circuit, which is so arranged that it bridges over the first magnet and is adapted to prevent the spacing between the first magnet and the second magnet exceeding a maximum spacing in the case of an excess pressure. An advantage with this embodiment is that the additional electronic component can also be installed in the context of a conventional fitment procedure with an automatic fitting apparatus. An arrangement for example is conceivable in which an ohmic resistor spatially (in contrast to electrically) bridges over the first magnet arranged on the sealing closure, and in that respect mechanically stabilizes it. The aspect of bridging over the first magnet serves primarily for preventing a predetermined spacing from being exceeded, but not for guiding the sealing closure during a stroke movement of the sealing closure, that is caused by virtue of an excess pressure in the fluid passage. Preferably, as already described, guidance of the moveable magnet is effected by the magnetic force itself.

In a further preferred embodiment the first magnet and the second magnet are so arranged that in the closed condition of the pressure-relief valve arrangement they are not in direct contact with a fluid in the fluid passage, That embodiment has the advantage that the material of the first and second magnets does not have to be adapted to the chemical composition of a fluid in the fluid passage. For example it is preferable for the first magnet to be coated at least on the side towards the fluid passage with epoxy, for example with a 10 μm thick epoxy layer.

The circuit board according to the invention is preferably a multi-layer circuit board. In the case of a multi-layer circuit board fluid passages can be comparatively easily implemented, for example as described in laid-open specification DE 197 397 22 A1. All layers of the multi-layer circuit board are preferably conventional glass fiber-reinforced epoxy resin circuit boards, for example those with a material identification FR4.

An insufflator forms a second aspect of the present invention. Insufflators are used in laparoscopy (endoscopic abdominal surgery) and serve to give an operator an unobstructed view of the operating field in the abdomen through an endoscope by feeding carbon dioxide (CO₂) into the abdomen. For that purpose CO₂ gas is insufflated into the abdomen through a so-called Veress cannula or a trocar at a maximum pressure of 30 mm_{Hg}. Due to the increasing internal pressure the abdominal wall (peritoneum) is lifted up and the desired cavity which allows endoscopic observation of the operating field is formed in the abdomen.

The insufflator of the second aspect of the present invention has a circuit board according to the first aspect of the invention. A substantial advantage of the insufflator is its particularly secure and reliable mode of operation which is based in particular on an inexpensive, compact and operationally reliable pressure-relief valve arrangement with an excellent opening and closing characteristic for the circuit board.

A further advantage of the insufflator according to the invention is that the circuit board with the at least one fluid passage corresponds moreover to those circuit boards as are used in known devices for electronic components so that the electronic components are assembled together to form a structural unit by way of the circuit board with the fluidic components of an insufflator, which are otherwise implemented separately.

For example the insufflator of the second aspect of the present invention is of such a configuration that it has a supply connection and a delivery connection and a pressure and flow measuring device arranged between said connections for determining a gas pressure at the delivery connection and for determining measurement parameters characterizing a gas volume flow at the delivery connection, which includes the circuit board, wherein
the fluid passage of the circuit board is connected at its inlet to the supply connection and at its outlet to the delivery connection, and
arranged on the circuit board are pressure measuring sensors and electronic components for connection of the pressure measuring sensors, of which the pressure measuring sensors are respectively in direct communication with the fluid passage through a corresponding opening in a circuit board layer and are adapted to deliver an output value representing the static pressure at the location of the respective opening.

In a preferred embodiment of the insufflator the fluid passage is formed by a cavity in the circuit board, which is so shaped that it has a portion which acts as a flow throttle and allows volume flow measurement on the basis of the principle of the pneumotachograph.

Preferably in this embodiment arranged at the inlet and at the outlet of the portion of the cavity, that acts as the flow throttle, are respective pressure sensors which are connected to electronic components and which are adapted to determine a difference between the static pressure at the inlet of the portion of the cavity, that acts as the flow throttle, and the static pressure at the outlet of the portion of the cavity, that acts as the flow throttle. The insufflator is accordingly preferably adapted to implement flow regulation by pressure regulation. For that purpose in an embodiment the insufflator is adapted to operate on the basis of a low-pressure principle in which the insufflation pressure is equal to a reference or target pressure which generally corresponds to a theoretical maximum pressure in the abdomen. By virtue of a pressure drop by way of an inlet and along a wall of a tube leading to the abdomen a lower pressure actually prevails in the abdomen than the reference pressure. That procedure generally represents a continuous procedure.

In another embodiment the insufflator is adapted to operate on the basis of an excess pressure principle in which the insufflation pressure is stepwise set higher than the reference pressure, in which case measurement of an intraabdominal pressure is cyclically effected here in pauses in which the insufflation pressure and the volume flow are set to an amount of respectively about zero. That excess pressure procedure generally represents an intermittent procedure.

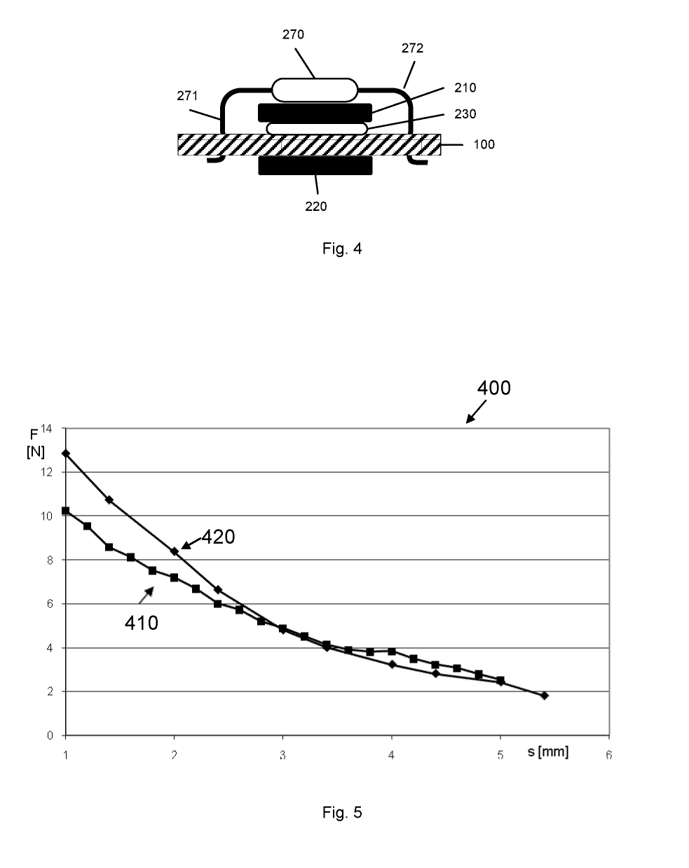

In a preferred embodiment the insufflator is adapted to introduce the gas into the body of the patient in a quasi-continuous procedure in accordance with the procedure of the publication of European patent application EP 1352669 A1. Accordingly attention is explicitly directed to that publication, in particular to the embodiments of FIGS. 4 and 5.

Further advantages of the present invention are described hereinafter with reference to the drawing in which:

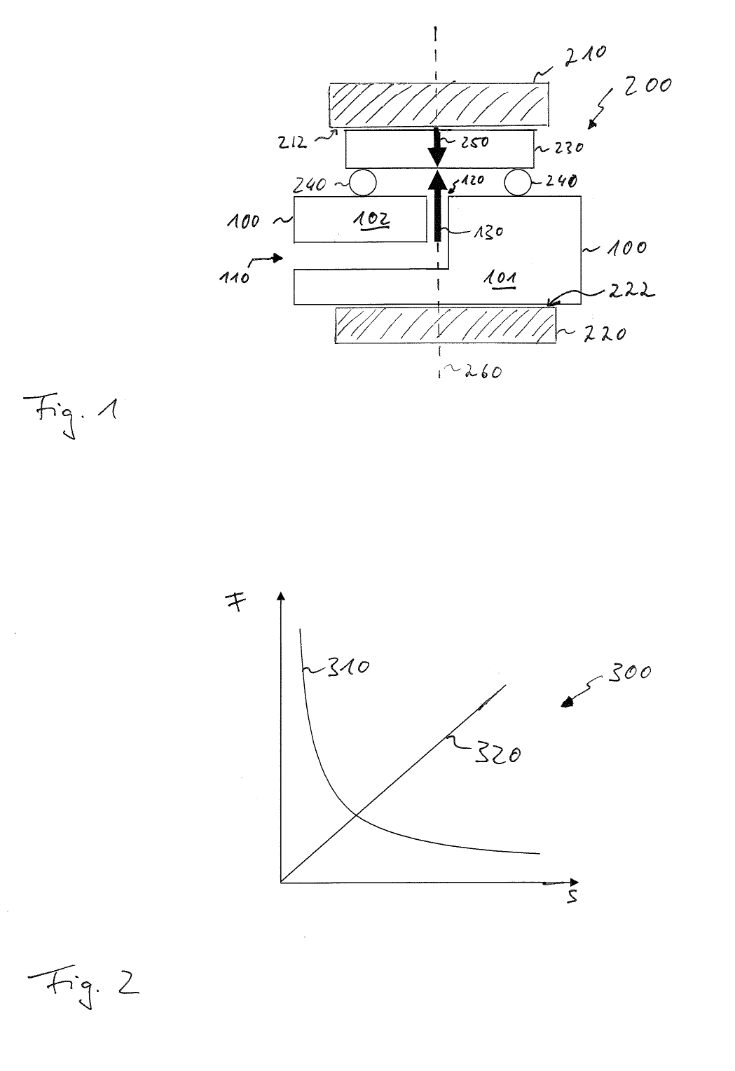

FIG. 1 shows a diagrammatic view of an embodiment of the circuit board according to the invention with an excess pressure valve arrangement,

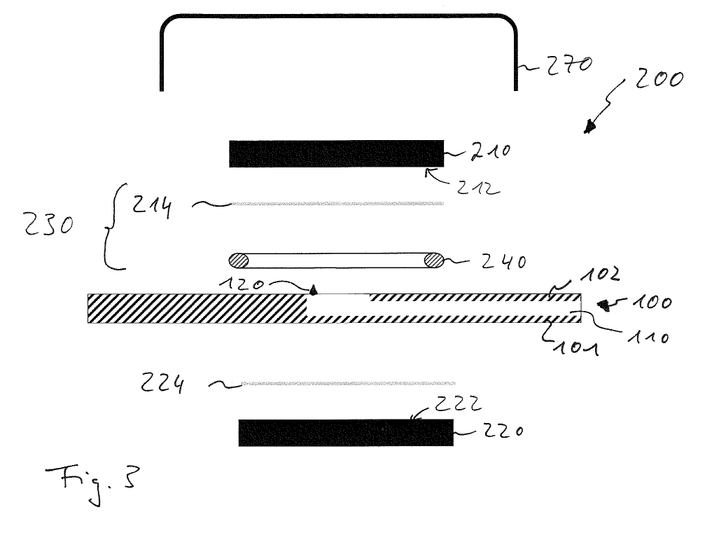

FIG. 2 shows a force-travel diagram,

FIG. 3 shows a diagrammatic view of the structure in principle of an embodiment of a pressure-relief valve arrangement of the circuit board,

FIG. 4 shows a photograph of a pressure-relief valve arrangement arranged on a circuit board with a fluid passage,

FIG. 5 shows a further force-travel diagram,

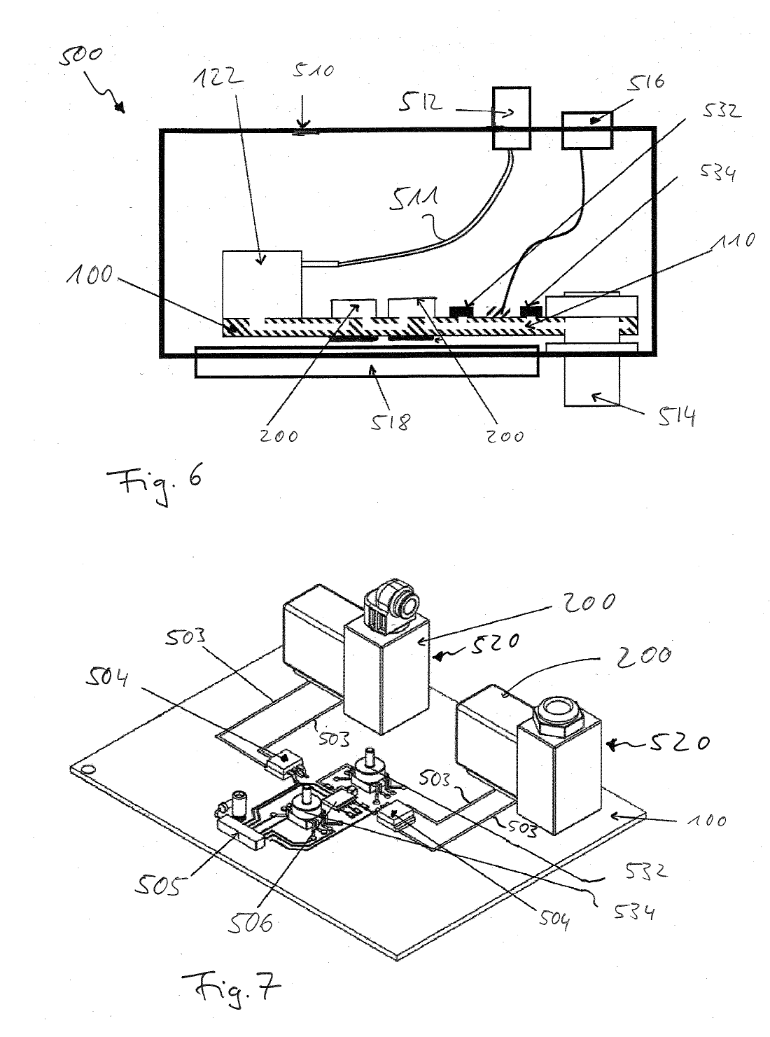

FIG. 6 shows a diagrammatic view of a cross-section through an insufflator according to the invention, and

FIG. 7 shows a diagrammatic plan view of a circuit board of the insufflator according to the invention.

FIG. 1 is a diagrammatic cross-sectional view of a circuit board 100 according to the invention with pressure-relief valve arrangement 200. The circuit board 100 is a multi-layer circuit board having at least two layers, the first layer 101 and the second layer 102.

In its interior the circuit board 100 has at least one fluid passage 110 which can carry a fluid, like for example CO₂ or H₂O. The fluid passage 110 in FIG. 1 can lead to a fluid passage system which is arranged in the interior of the circuit board 100 but which is not shown in FIG. 1. On a surface the circuit board 100 has a fluid passage opening 120 which leads to the fluid passage 110. A sealing closure 230 with a sealing element 240 in the form of an O-ring can be arranged over the fluid passage opening 120. A first magnet 210 is fixed, for example glued, on the sealing closure 230. A second magnet 220 is fixed, for example also glued, on a side of the circuit board 100, that is remote from the fluid passage opening 120. The first magnet 210, the second magnet 220 and the sealing closure 230 together with the sealing element 240 are part of the pressure-relief valve arrangement 200.

A magnetic force indicated by the arrow 250 is operative between the first magnet 210 and the second magnet 220 so that the sealing closure 230 is pressed on to the fluid passage opening 120 and seals it off. If a pressure is produced in the fluid passage 110 then a pressing force indicated by the arrow 130 acts in a direction in opposition to the magnetic force 250, If the pressing force 130 exceeds the magnetic force 250 the pressure-relief valve arrangement 200 opens and an excess pressure in the fluid passage 110 is reduced.

The first magnet 210 can be for example a permanent magnet. The second magnet 220 can be for example a metallic plate. The terms first magnet and second magnet are accordingly to be interpreted in a technically functional sense, that a magnetic force acts between them. Contrary to the view in FIG. 1 the second magnet can be integrated in the first layer 101 of the circuit board 100.

In the embodiment shown in FIG. 1 of the circuit board according to the invention the first magnet 210 and the second magnet 220 have mutually facing surfaces 212, 222 which are respectively arranged substantially centered and substantially perpendicular to a notional vertical axis 260 and which are of substantially the same shape, That configuration has the advantage that the first magnet 210 and the second magnet 220 produce a magnetic force 250 which counteracts a displacement of the first magnet 210 out of the illustrated central position. The magnetic force 250 therefore counteracts both a tilting movement of the first magnet 210, that is to say a condition in which the surface 212 of the first magnet 210 is not perpendicular to the notional axis 260, and also a displacement of the first magnet 210 in the horizontal direction towards left or right.

FIG. 1 also indicates that the first magnet 210 and the second magnet 220 each have a planar body in which the width is substantially greater than the height, That is to the benefit of a compact structure for the circuit board 100.

FIG. 1 also shows that the first magnet 210 and the second magnet 220 are so arranged that they are not in direct contact with a fluid in the fluid passage 110. That has the advantage that the material of the first magnet 210 and the material of the second magnet 220 does not have to be adapted to the chemical composition of a fluid in the fluid passage 110,

An advantage of the pressure-relief valve arrangement 200 over a valve operated with a spring is indicated in FIG. 2. FIG. 2 shows a force-travel diagram for a magnetic force between the first and second magnets 210, 220 and for the situation where a seal is not pressed against an opening by a magnetic force but by a spring force. The force is plotted on the ordinate in the force-travel diagram 300 and the travel is plotted on the abscissa. The configuration 310 represents the variation in a magnetic force and the configuration 320 represents the variation in a mechanical spring force,

A first advantage of the pressure-relief valve arrangement operated by means of magnetic force is that the magnetic force increases with decreasing spacing so that the force 250 shown in FIG. 1 in the closed condition of the pressure-relief valve arrangement 200 assumes a maximum. In contrast, to build up a high force by means of a spring, a certain distance must be available, which accordingly is manifested in particular in a larger and more complicated and expensive structure. When the valve opens by virtue of an excess pressure, then in the case of the magnet the excess pressure is reduced more quickly as the closing force decreases with increasing spacing and the magnet-operated valve opens more quickly in that respect. In contrast, in the case of a valve operated with a spring, the closing force increases with increasing spacing.

FIG. 3 is a diagrammatic cross-sectional view through the circuit board 100 with the pressure-relief valve arrangement 200. The structure in FIG. 3 is basically the same as that shown in FIG. 1, while FIG. 3 additionally shows a preferred variant of the sealing closure 230. In this case the sealing closure 230 is formed by a first adhesive layer 214 and the sealing element 240 in the form of an O-ring. Upon installation of the pressure-relief valve arrangement 200 the O-ring 240 is glued on the first adhesive layer 214 on the underside and the first magnet 210 from above. The first adhesive 214 therefore also functions as a sealing film.

The second magnet 220 is preferably glued on the side of the circuit board 100, that is remote from the fluid passage opening 120, by means of a second adhesive layer 224. FIG. 3 therefore again shows the compact structure of the pressure-relief valve arrangement 200. In order to avoid the first magnet 210 with the sealing closure 230 glued thereon moving away from the glued-on second magnet 220 excessively far in the case of an excess pressure in the fluid passage 110, there is provided a holding device 270 which bridges over the first magnet 210. That holding device 270 is preferably an electronic component like a passive electronic component like an ohmic resistor or a capacitor or an active electronic component like a transistor or an integrated circuit. That has the advantage that the holding device 270 can also be installed on the circuit board 100 in the course of a board equipping process by means of an automatic fitting apparatus.

FIG. 4 shows a photograph of an implemented circuit board 100 with a pressure-relief valve arrangement, the structure of which substantially corresponds to that diagrammatically shown in FIG. 3. Here an ohmic resistor was used as the holding device 270, which bridges over the first magnet 210 and the sealing closure 230 by means of its solder arms 271, 272 and in that respect prevents the magnet 210 together with the sealing closure 230 moving too far away from the second magnet 220 beneath the circuit board 100 in the event of an excess pressure in the fluid passage which is not visible in FIG. 4.

The first magnet 210 and the second magnet 220 in FIG. 4 comprise a neodymium-iron-boron alloy of grade N35 and are each of a diameter of 12 mm and a height of 2.5 mm, The pressure-relief valve arrangement shown in FIG. 4 opens approximately at a pressure in the fluid passage of between 290 and 310 mBar.

As already explained in detail at another point however that pressure range can be adjusted as desired, for example by the selection of a given magnet material and by varying the dimensions of the first magnet 210 and the second magnet 220. Basically it is advantageous if the material of the sealing closure, in particular the sealing element in the configuration of an O-ring, is so selected that adhesion to the circuit board 100 is avoided so that the pressure-relief valve arrangement in fact opens at an excess pressure that is the same in each case in the fluid passage 110.

The pressure-relief valve arrangement shown in FIG. 4 was designed for an excess pressure of about 300 mBar. The diameter of the sealing closure 230 is about 10 mm. Overall the pressure-relief valve arrangement shown in FIG. 4 in the closed condition involves a magnetic force of about 2.4 N. Accordingly the pressure-relief valve arrangement opens at an excess pressure in the fluid passage, which causes a pressure force of greater than 2.4 N.

Subsequently FIG. 5 shows a further force-travel diagram 400 which on the one hand represents a measured force-travel configuration 410 and on the other hand, in comparison therewith, a simulated force-travel configuration 420. Both measurement and also simulation relate to the arrangement shown in FIG. 4. Once again the force is plotted on the ordinate and the spacing between the first magnet 210 and the second magnet 220 in FIG. 4 is plotted on the abscissa. The simulation results are very substantially based on estimations and table values. That simulation was implemented with the COMSOL 3.4 program. In that case the influence of a material as between the first magnet and the second magnet was not considered. Both the simulation results 420 and also the measurement results 410 show that a distance between the first magnet 210 and the second magnet 220 of about 4.5 mm is suitable, for a force of about 2.4 N. If neither the sealing element 214 nor the second magnet 220 is embedded in the circuit board, the above-mentioned distance is afforded merely by totaling the thicknesses of the second adhesive layer 224, the circuit board 100, the sealing element in the form of an O-ring 240 and the first adhesive layer 214.

FIG. 6 diagrammatically indicates a housing 510 of an insufflator 500 according to the invention, at which there is provided a CO₂ connection to a source for gaseous CO₂, as well as a delivery connection 514 to which a tube is to be connected for introduction into the abdomen of a patient. The insufflator 500 also has an electric power connection 516 and an operating panel 518.

The core element of the insufflator 500 is the circuit board 100 to which a supply connection 122 and the delivery connection 514 are gas-tightly glued. The supply connection 122 is connected to the CO₂ connection 512 by way of a suitable tube 511.

The circuit board 100 in FIG. 6 is a multi-layer board and has in its interior cavities forming a plurality of fluid passages 110. The supply connection 122 and the delivery connection 514 are in fluid communication with the fluid passage 110. Electric and electronic components of the insufflator 500 are also mounted on the outside of the circuit board 100 and there is at least one pressure-relief valve arrangement 200. The Figure shows two pressure-relief valve arrangements 200, in which case a single one can also achieve the described advantages for the insufflator.

The pressure-relief valve arrangements 200 are also gas-tightly glued on the circuit board 100. Accordingly the circuit board 100 of the insufflator 500 includes two pressure-relief valve arrangements 200 which respectively protect two fluid passage openings.

There are also pressure sensors 532, 534 which are in the form of differential pressure sensors and which are gas-tightly glued rearwardly on the circuit board 100.

The various portions of the fluid passage 110 in the interior of the circuit board are of an internal height of about 1 mm and an internal width of between 1 mm and 8 mm.

The insufflator 500 allows a gas volume flow CO₂ of up to 44 l/min, It is designed for an intraabdominal pressure of about between 1 and 30 mm_{Hg}. An intermittent gas flow is possible by virtue of the pressure-relief valve arrangements 200.

FIG. 7 is a diagrammatic view showing once again the core element of the insufflator 500 of FIG. 6, namely the multi-layer circuit board 100 with electronic and fluidic components which are mounted thereon and which are required for the insufflator 500 shown by way of example. These are the pressure-relief valves 200, electronic power components 504 connected to the pressure-relief valves 200 by way of conductor tracks 503, the pressure sensors 532 and 534, a plug connector 505 for connection to the power connection 516 (not shown in FIG. 7), a sensor signal processing means, a microcontroller 506, keys and displays.

The fluid passages in the interior of the multi-layer circuit board 100 cannot be seen in FIG. 7. They form the fluidic communication between the supply connection 122 and the delivery connection 514 as well as the pressure-relief valves 200 and the pressure sensors 532 and 534 which are also arranged in the form of pneumatic (fluidic) components on the circuit board 100. The fluidic components are so arranged that they have both fluidic contact with the fluid passages arranged in the interior of the circuit board 100 and also electrical contact with the electric and electronic components 504 and 506 of the insufflator 500. That double utilization of the circuit board 100 permits an insufflator to be of a compact and inexpensive structure.

### LIST OF REFERENCES

100 circuit board
101 first layer of the circuit board
102 second layer of the circuit board
110 fluid passage
120 fluid passage opening
122 supply connection
130 pressure force
200 pressure-relief valve arrangement
210 first magnet
212 surface of the first magnet, that is towards the fluid passage
214 first adhesive layer
220 second magnet
222 surface of the second magnet, that is towards the fluid passage
224 second adhesive layer
230 sealing closure
240 sealing element
250 magnetic force or closing force
260 notional vertical axis
270 holding device
271, 272 solder arms
300 force-travel diagram
310 magnetic force in dependence on a distance
320 spring force in dependence on a
400 further force-travel diagram
410 measured force-travel configuration
420 simulated force-travel configuration
500 insufflator
503 conductor tracks
504 electronic power components
505 power connection
506 microcontroller
510 housing of the insufflator tube
512 CO₂ connection
514 delivery connection
516 power connection
518 operating panel
520 housing of the pressure-relief valve arrangement
532, 534 pressure sensors

1. A circuit board having at least one fluid passage arranged in the interior of the circuit board, comprising:
a fluid passage opening which is arranged on a surface of the circuit board and which leads to the fluid passage, and
a multi-part pressure-relief valve arrangement for reducing an excess pressure in the fluid passage, which includes a first magnet, a second magnet and a sealing closure, wherein
the first magnet and the second magnet are so arranged that they press the sealing closure on to the fluid passage opening by a magnetic force afforded by the first magnet and by the second magnet.

2. The circuit board as set forth in claim 1 in which the first magnet is fixed on the sealing closure and the second magnet is fixed on a side of the circuit board, that is remote from the fluid passage opening.

3. The circuit board as set forth in claim 1 in which the first magnet and the second magnet are so arranged that the magnetic force acts in opposition to a displacement of the first magnet out of a central position.

4. The circuit board as set forth in claim 1 in which the first magnet and the second magnet have mutually facing surfaces which are respectively arranged substantially centered and substantially perpendicular to a notional vertical axis and are of substantially the same shape

5. The circuit board as set forth in claim 1 in which the second magnet is embedded in an opening in the circuit board.

6. The circuit board as set forth in claim 1 in which the first magnet and the second magnet respectively have a planar body in which the width is substantially greater than the height.

7. The circuit board as set forth in claim 1 in which the sealing closure has a sealing element which in the closed condition of the pressure-relief valve arrangement is embedded in openings in the circuit board.

8. The circuit board as set forth in claim 1 in which the sealing closure includes an O-ring as the sealing element.

9. The circuit board (100) as set forth in claim 1 including an electronic component which is so arranged that it bridges over the first magnet and is adapted to prevent the spacing between the first magnet and the second magnet exceeding a maximum spacing in the case of an excess pressure.

10. The circuit board as set forth in claim 1 in which the first magnet and the second magnet are so arranged that in the closed condition of the pressure-relief valve arrangement they are not in direct contact with a fluid in the fluid passage.

11. The circuit board as set forth in claim 1 wherein the circuit board is a multi-layer circuit board.

12. An insufflator having a circuit board as set forth in claim 1.

13. The insufflator as set forth in claim 12 wherein the insufflator has a supply connection and a delivery connection and a pressure and flow measuring device arranged between said connections for determining a gas pressure at the delivery connection and for determining measurement parameters characterizing a gas volume flow at the delivery connection, which includes the circuit board, wherein,
the fluid passage of the circuit board is connected at its inlet to the supply connection and at its outlet to the delivery connection, and
arranged on the circuit board are pressure measuring sensors and electronic components for connection of the pressure measuring sensors, of which the pressure measuring sensors are respectively in direct communication with the fluid passage through a corresponding opening in a circuit board layer and are adapted to deliver an output value representing the static pressure at the location of the respective opening.

14. The insufflator as set forth in claim 13 in which the fluid passage is formed by a cavity in the circuit board, which is so shaped that it has a portion which acts as a flow throttle and allows volume flow measurement on the basis of the principle of the pneumotachograph.

15. The insufflator as set forth in claim 14 in which arranged at the inlet and at the outlet of the portion of the cavity, that acts as the flow throttle, are respective pressure sensors which are connected to electronic components and which are adapted to determine a difference between the static pressure at the inlet of the portion of the cavity, that acts as the flow throttle and the static pressure at the outlet of the portion of the cavity, that acts as the flow throttle.

16. The circuit board as set forth in claim 9, wherein the electronic component is a resistor capacity, transistor, or an integrated circuit.
